(19) United States
(12) Patent Application Publication
(10) Pub. No.: US 2011/0059262 A1
(43) Pub. Date: Mar. 10, 2011

(54) AQUEOUS FLOOR COATINGS BASED ON UV-CURABLE POLYURETHANE DISPERSONS

(75) Inventors: Aaron A. Lockhart, Pittsburgh, PA (US); Robert A. Wade, Oakdale, PA (US); Michael J. Dvorchak, Monroeville, PA (US); Clifford M. Bridges, Pittsburgh, PA (US)

(73) Assignee: Bayer MaterialScience LLC, Pittsburgh, PA (US)

(21) Appl. No.: 12/920,840

(22) PCT Filed: Mar. 4, 2009
(86) PCT No.: PCT/US09/01363

§ 371 Date: Nov. 3, 2010

Related U.S. Application Data
(60) Provisional application No. 61/068,292, filed on Mar. 6, 2008.

(51) Int. Cl. B05D 3/06

(52) U.S. Cl. 427/508

(57) ABSTRACT

The present invention is directed to a process for coating a wood substrate, the coating composition curable by radiation having a wavelength of 320 nm to 450 nm and the coated product so-produced.

### BACKGROUND OF THE INVENTION

UV curable coatings are one of the fastest growing sectors in the coatings industry. In recent years, UV technology has made inroads into a number of market segments like fiber optics, optical- and pressure sensitive adhesives, automotive applications like UV cured topcoats, and UV curable powder coatings. The driving force of this development is mostly the quest for an increase in productivity of the coating and curing process. Safety concerns associated with the use of UV lamps in do-it-yourself applications, as well as economic constraints will likely preclude the use of high intensity light sources. Relatively inexpensive low intensity lamps that emit only in the UV-A region of the electromagnetic spectrum are taking their place thus posing new challenges to resin developers and formulators.

UV curable coating compositions are known in the art. U.S. Pat. No. 5,684,081 describes a radiation-curable, aqueous dispersion, although the reference is silent as to the wavelength of the radiation to be used. Also known are compositions that are curable using UV radiation having a very low UV-B content and substantially no UV-C content (see, e.g., U.S. Patent application publication 2003/0059555 and U.S. Pat. No. 6,538,044). The compositions described in the '044 patent are fragranced lacquer coatings that are non-aqueous and are not based on urethane chemistry. The '555 publication describes solvent-based compositions useful as primers. The compositions therein are non-aqueous and require wiping of the coating with an organic solvent following exposure to UV radiation and before sanding of the coated part.

U.S. Pat. No. 6,559,225 describes an aqueous polyurethane dispersion for use in lacquers and coatings. The '225 patent does not describe UV curing, and hints that the dispersions described therein can be combined with radiation-curable binders (column 5, lines 17-20). Finally, U.S. Pat. No. 6,579,932 describes an aqueous coating composition which is a mixture of a polyurethane/acrylate hybrid dispersion and a polyurethane resin with oxidative drying groups. The '932 patent does not describe UV curing.

It is an object of the present invention to provide a process for coating a wood substrate, preferably a wood floor, most preferably a previously-installed wood floor, wherein the coating composition may be safely and rapidly cured using UV-A radiation.

### SUMMARY OF THE INVENTION

The present invention is directed to a process for coating a wood substrate, comprising applying an aqueous coating composition to the substrate and subjecting the coated substrate to radiation having a wavelength of 320nm to 450 nm for a time sufficient to cure the composition, wherein the aqueous coating composition comprises:
A) a polyurethane dispersion comprising:
   a) from about 25 to about 89.8% (and preferably from about 30 to about 80%) by weight of one or more acrylate polymers containing hydroxyl groups and having an OH number of from about 40 to about 240,
   b) from 0.1 to about 20% (and preferably from about 2 to about 15%) by weight of one or more compounds containing i) one and/or two functional groups compounds reactive towards isocyanate groups and ii) groups which are cationic and/or anionic and/or have a dispersant action due to ether groups content,
   c) from about 10 to about 50% (and preferably from about 15 to about 40%) by weight of one or more di- and/or polyisocyanates,
   d) from 0 to about 30% (and preferably from 0 to about 20%) by weight of a di-and/or polyol having a number average molecular weight of up to about 5000, an OH functionality of from 1.2 to 2.2, containing no groups which are cationic or anionic, containing ari insufficient amount of ether groups to have a dispersant action, and containing no ethylenically unsaturated groups and
   e) from about 0.1 to about 10% (and preferably from about 0.5 to about 7%) by weight of one or more di- and/or polyamines having a number average molecular weight of from about 31 to about 1000,
      wherein the percents by weight are based on the total amount of components a) through e) and total 100%,
B) from about 0.1 to about 10% by weight of one or more photoinitiators, wherein the % by weight of component B) is based on the weight of component A), and
C) from about 20 to about 60% by weight of water or a mixture of water and solvent, wherein the % by weight of component C) is based on the solids content of component A).

### DETAILED DESCRIPTION OF THE INVENTION

The composition of the present invention comprises an aqueous polyurethane dispersion A) prepared from components comprising:
a) from about 25 to about 89.8% (and preferably from about 30 to about 80%) by weight of one or more acrylate polymers containing hydroxyl groups and having an OH number of from about 40 to about 240,
b) from 0.1 to about 20% (and preferably from about 2 to about 15%) by weight of one or more compounds containing i) one and/or two functional groups compounds reactive towards isocyanate groups and ii) groups which are cationic and/or anionic and/or have a dispersant action due to ether groups content,
c) from about 10 to about 50% (and preferably from about 15 to about 40%) by weight of one or more di- and/or polyisocyanates,
d) from 0 to about 30% (and preferably from 0 to about 20%) by weight of a di-and/or polyol having a number average molecular weight of up to about 5000, an OH functionality of from 1.2 to 2.2, containing no groups which are cationic or anionic, containing an insufficient amount of ether groups to have a dispersant action, and containing no ethylenically unsaturated groups and
e) from about 0.1 to about 10% (and preferably from about 05 to about 7%) by weight of one or more di- and/or polyamines having a number average molecular weight of from about 31 to about 1000,
   wherein the percents by weight are based on the total amount of components a) through e) and total 100%.

The acrylate polymers a) are polycondensation products derived from polycarboxylic acids or the anhydrides thereof (such as, for example, adipic acid, sebacic acid maleic anhydride, fumaric acid and phthalic acid), di- and/or more highly functional polyols (such as for example ethylene glycol, propylene glycol, neopentyl glycol, trimethylol-propane, pentaerythritol, alkoxylated di- or polyols and the like) and acrylic and/or methacrylic acid. After polycondensation, excess carboxyl groups may be reacted with epoxides. Production of the acrylate polymers a) containing hydroxyl groups is described in U.S. Pat. No. 4,206205, German Offenlegungschrifften 4,040,290, 3,316,592, and 3,704,098 and in UV & EB Curing Formulations for Printing Inks, Coatings & Paints, ed. R. Holman and P. Oldring, published by SITA Technology, London (England), 1988, pages 36 et seq. The reactions should be terminated once the OH number is within the range from about 40 to about 240. It is also possible to use polyepoxy acrylate polymers containing hydroxyl groups or polyurethane acrylate polymers containing hydroxyl groups. The C=C% can generally range from 0.1 to 10 moles/kg, based on the weight of component a).

Compounds b) which have a dispersant action effected cationically, anionically and/or by ether groups are those containing, for example, sulphonium, ammonium, carboxylate, sulphonate and/or polyether groups and contain isocyanate-reactive groups. Preferred suitable isocyanate reactive groups are hydroxyl and amine groups. Representatives of compounds b) are bis(hydroxymethyl)propionic acid, maleic acid, glycolic acid, lactic acid, glycine, alanine, taurine, 2-aminoethylaminoethane-sulphonic acid, polyoxyethylene glycols and polyoxypropylene/oxyethylene glycols started on alcohols. Bis(hydroxy-methyl) propionic acid and polyethylene glycol monomethyl ether are particularly are particularly preferred.

The component c) can be aromatic, araliphatic, aliphatic or cycloaliphatic di- and/or polyisocyanates and mixtures of such isocyanates. Preferred are diisocyanates of the formula R¹(NCO)₂, wherein R¹ represents an aliphatic hydrocarbon residue having 4 to 12 carbon atoms, a cycloaliphatic hydrocarbon residue having 6 to 15 carbon atoms, an aromatic hydrocarbon residue having 6 to 15 carbon atoms or an araliphatic hydrocarbon residue having 7 to 15 carbon atoms. Specific examples of suitable isocyanates include tetramethylene diisocyanate, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4- or 4,4′-diphenylmethane diisocyanate, α,α,α′,α′-tetramethyl-m- or -p-xylylene diisocyanate, and triphenylmethane 4,4′,4″-triisocyanate as well as mixtures thereof.

Polyisocyanates having isocyanurate, biuret, allophanate, uretidione or carbodiimide groups are also useful as the isocyanate component. Such polyisocyanates may have isocyanate functionalities of 3 or more. Such isocyanates are prepared by the trimerization or oligomerization of diisocyanates or by the reaction of diisocyanates with polyfunctional compounds containing hydroxyl or amine groups. Preferred is the isocyanurate of hexamethylene diisocyanate. Further suitable compounds are blocked polyisocyanates, such as 1,3,5-tris-[6-(1-methyl-propylidene aminoxy carbonylamino)hexyl]-2,4,6-trioxo-hexahydro-1,3,5-triazine.

Hexamethylene diisocyanate; 4,4′-dicyclohexylmethane diisocyanate and isophorone diisocyanate and the mixtures thereof are the presently preferred isocyanates.

As di-and/or polyols d), it is possible to use substances with a molecular weight up to 5000. Suitable diols include, for example, propylene glycol, ethylene glycol, neopentyl glycol and 1,6-hexane diol. Examples of higher molecular weight polyols are the well known polyesterpolyols, polyetherpolyols and polycarbonate polyols which should have an average OH functionality of from about 1.8 to about 2.2. If appropriate it is also possible to use monofunctional alcohols such as ethanol and butanol.

Di- and/or polyamines e) are used to increase molecular weight. Since this reaction proceeds in the aqueous medium, the di- and/or polyamines must be more reactive towards the isocyanate groups than water. Compounds which may be cited by way of example are ethylenediamine, 1,6-hexamethylenediamine, isophoronediamine, 1,3- and 1,4-phenylenediamine, 4,4′-diphenylmethanediamine, aminofunctional polyethylene oxides and polypropylene oxides (sold under the Jeffamine trademark), triethylenetetramine and hydrazine. Ethylenediamine is particularly preferred. It is also possible to add certain proportions of monoamines, and as for example butylamine and ethylamine.

The polyester acrylate/urethane dispersions according to the invention may be produced using any known prior art methods, such as emulsifier/shear force, acetone, prepolymer mixing, melt/emulsification, ketimine and solid spontaneous dispersion methods or derivatives thereof (c.f. Methoden der Organischen Chemie, Houben-Weyl, 4th edition, volume E20/part 2, page 1682, Georg Thieme Verlag, Stuttgart, 1987). Experience has shown that the acetone method is the most suitable.

Components a), b) and d) are initially introduced into the reactor in order to produce the intermediates (polyester acrylate/urethane solutions), diluted with a solvent which is miscible with water but inert towards isocyanate groups and heated to relatively elevated temperatures, in particular in the range from 50° to 120° C. Suitable solvents are acetone, butanone, tetrahydrofuran, dioxane, acetonitrile and 1-methyl-2-pyrrolidone. Catalysts known to accelerate the isocyanate addition reaction may also be initially introduced, for example triethylamine, 1,4-diazabicyclo[2,2,2]octane, tin dioctoate or dibutyltin dilaurate. The polyisocyanate and/or polyisocyanates are added to these mixtures. The ratio of moles of all hydroxyl groups to moles of all isocyanate groups is generally between 0.3 and 0.95, in particular between 0.4 and 0.9.

Once the polyester acrylate/urethane solutions have been produced from a), b), c) and d), the component b) having an anionic or cationic dispersant action undergoes salt formation, unless this has already occurred in the starting molecules. In the case of anionic containing components, bases such as ammonia, triethylamine, triethanolamine, potassium hydroxide or sodium carbonate may advantageously be used, while in the case of cationic containing components, sulphuric acid dimethyl ester or succinic acid may advantageously be used. If component b) contains a sufficient amount of ether groups, the neutralization stage is omitted.

In the final reaction stage, in which an increase in molecular weight and the formation of the polyester acrylate/urethane dispersions occur in the aqueous medium, the polyester urethane solutions prepared from components a), b), c) and d) are either vigorously stirred into the dispersion water containing component e) or, conversely, the water/component e) mixture is stirred into the polyester urethane solutions. Molecular weight is then increased by the reaction of the isocyanate groups still present with the amine hydrogens and the dispersion is also formed. The quantity of component e) used is dependent upon the unreacted isocyanate groups which are still present.

If desired, the solvent may be removed by distillation. The dispersions then have a solids content of from about 20 to about 60% and preferably form about 30 to about 55% by weight.

### Photoinitiator

The photoinitiator can be substantially any photoinitiator. A variety of photoinitiators can be utilized in the radiation-curing compositions of the present invention. The usual photoinitiators are the type that generate free radicals when exposed to radiation energy. Suitable photoinitiators include, for example, aromatic ketone compounds, such as benzo-phenones, alkylbenzophenones, Michler's ketone, anthrone and halogenated benzophenones. Further suitable compounds include, for example, 2,4,6-trimethylbenzoyldiphenylphosphine oxide, phenylglyoxylic acid esters, anthraquinone and the derivatives thereof, benzil ketals and hydroxyalkylphenones. Illustrative of additional suitable photoinitiators include 2,2-diethoxyacetophenone; 2- or 3- or 4-bromoacetophenone; 3- or 4-allyl-acetophenone; 2-acetonaphthone; benzaldehyde; benzoin; the alkyl benzoin ethers; benzophenone; benzoquinone; 1-chloroanthra-quinone; p-diacetyl-benzene; 9,10-dibromoanthracene; 9,10-dichloro-anthracene; 4,4-dichlorobenzophenone; thioxanthone; isopropyl-thioxanthone; methylthioxanthone; α,α,α-trichloro-para-t-butyl aceto-phenone; 4-methoxybenzophenone; 3-chloro-8-nonylxanthone; 3-iodo-7-methoxyxanthone; carbazole; 4-chloro-4′-benzylbenzophenone; fluoroene; fluoroenone; 1,4-naphthylphenylketone; 1,3-pentanedione; 2,2-di-sec-butoxy acetophenone; dimethoxyphenyl acetophenone; propiophenone; isopropylthioxanthone; chlorothioxanthone; xanthone; maleimides and their derivatives; and mixtures thereof. There are several suitable photoinitiators commercially available from Ciba including Irgacure 184 (1-hydroxy-cyclohexyl-phenyl-ketone), Irgacure 819 (bis(2,4,6-trimethyl-benzoyl)-phenylphosphineoxide), Irgacure 1850 (a 50/50 mixture of bis(2,6-dimethoxybenzoyl)-2,4,4-trimethylpentyl-phosphine oxide and 1-hydroxy-cyclohexyl-phenyl-ketone), Irgacure 1700 (a 25/75 mixture of bis(2,6-dimethoxybenzoyl)-2,4,4-trimethylpentyl-phosphine oxide and 2-hydroxy-2-methyl-1-phenyl-propan-1-one), Irgacure 907 (2-methyl-1[4-(methylthio)phenyl]-2-morpholonopropan-1-one), Darocur MBF (a phenyl glyoxylic acid methyl ester) and Darocur 4265 (a 50/50 mixture of bis(2,4,6-trimethylbenzoyl)-phenylphosphineoxide and 2-hydroxy-2-methyl-1-phenyl-propan-1-one). The foregoing lists are meant to be illustrative only and are not meant to exclude any suitable photoinitiators.

Those skilled in the art will know the concentrations at which photo-initiators are effectively employed and generally the concentration will not exceed about 10% by weight of the radiation-curable coating composition.

Those skilled in the art of photochemistry are fully aware that photoactivators can be used in combination with the aforementioned photoinitiators and that synergistic effects are sometimes achieved when such combinations are used. Photoactivators are well known in the art and require no further description to make known what they are and the concentrations at which they are effective. Nonetheless, one can mention as illustrative of suitable photoactivators, methylamine, tributylamine, methyldiethanolamine, 2-aminoethylethanolamine, allylamine, cyclo-hexylamine, cyclopentadienylamine, diphenylamine, ditolylamine, trixylylamine, tribenzylamine, n-cyclohexylethyleneimine, piperidine, N-methylpiperazine, 2,2-dimethyl-1,3-bis(3-N-morpholinyl)-propionyloxy-propane, and mixtures thereof.

### Other Additives

As is known in the art and depending on the application for the coating, additional additives can be used. Such additives include emulsifiers, dispersing agents, flow aid agents, thickening agents, defoaming agents, deaerating agents, pigments, fillers, flattening agents and wetting agents. In addition, where the article to be coated is of such a shape that portions of the coating may not be exposed to radiation, it is possible to add materials which crosslink through carboxyl groups, hydroxyl groups, amino groups or moisture. Such materials are known in the art and include carbodiimides, aziridines, polyvalent cations, melamine/formaldehyde, epoxies and isocyanates. Suitable carbodiimides are known and described, e.g., in U.S. Pat. Nos. 5,104,928, 5,574,083, 5,936,043, 6,194,522, 6,300,409 and 6,566,437, the disclosures of which are hereby incorporated by reference. Suitable hydrophilic isocyanates are also known in the art and are commercially available. One commercially available isocyanate is Bayhydur 2336, a. hydrophilic polyether modified hexamethylene diisocyanate trimer from Bayer Polymers LLC. When used, such crosslinkers should be used in an amount of from 0.1 to 35% by weight based on the combined weight of component A).

### Applying and Curing

Generally, component A) is prepared and then component C) and any other additives are added thereto. The composition of the invention may be applied onto the most varied substrates by spraying, rolling, knife-coating, pouring, brushing or dipping. The water present is then flashed off by baking in a conventional oven at a temperature of from about 20 to about 110° C. preferably from about 35 to about 60° C. for a period of from about 1 to about 10 minutes, preferably from about 4 to 8 minutes. The water can also be flashed off using a radiation source like infra-red or microwave.

Once the water has baked off, the coated substrate is subjected to UV radiation having a wavelength of at least 300 nm and preferably radiation having wavelength of from about 320 to about 450 nm. The distance between the surface and the radiation source will depend upon the intensity of the light source and should generally be no more than three feet. The length of time the coated substrate is subjected to the radiation will depend on the intensity and wavelength of the radiation, the distance from the radiation sources, water content in the formulation, temperature and the humidity of the cure surroundings but will generally be less than 10 minutes and may be as short as 0.1 second.

The cured coatings are distinguished by their sandability.

As noted above, the compositions are curable using radiation sources having wavelengths of at least 300 nm and preferably from about 320 to about 450 nm. The radiation can be provided by any suitable source such as UV lamps having reduced infrared emission or UV lamps fitted with filters to eliminate infrared emissions or so-called LEDs (light-emitting devices) emitting radiation in the wavelength noted. Particularly useful commercially available devices include: the Panacol UV H-254 lamp (available from Panacol-Elosol GmbH)—a 250 W ozone-free, iron doped metal halide lamp with spectral wavelength of from 320 to 450 nm; Panacol UVF-450 (320 nm to 450 nm depending on the black, blue ₉r clear filter used); Honle UVA HAND 250 CUL (available from Honle UV America Inc)—emitting maximum intensity UVA range of ˜320 to 390 nm; PMP 250 watt metal halide lamp (available from Pro Motor Car Products Inc); Cure-Tek UVA-400 (available from H&S. Autoshot) which has a 400-watt metal halide bulb and the lamp assembly can be fitted with different filters like blue, light blue or clear to contraeliminate the infra-red radiation from the lamp source); Cure-Tek UVA-1200 (available from H&S Autoshot) which has a 1200-watt metal halide bulb and the lamp assembly can be fitted with different filters like blue, light blue or clear to control/eliminate the infra-red radiation from the lamp source); Con-Trol-Cure Scarab-250 UV-A shop lamp system (available from UV Process Supply Inc.—has a 250 W iron doped metal halide lamp with a spectral wavelength output of 320 to 450 nm); Con-Trol-Cure—UV LED Cure-All 415 (available from UV Process Supply Inc.—spectral wavelength of 415 nm with a 2.5 to 7.95 W operating wattage range), the Con-Trol-Cure—UV LED Cure-All 390 (available from UV Process Supply Inc.—spectral wavelength of 390 nm with a 2.76 to 9.28 W operating wattage range) and the UV H253 UV lamp (available from UV Light Technologies—the unit contained a 250 W iron doped metal halide lamp fitted with a black glass filter to produce a spectral wavelength of between 300 and 400 nm).

Due to the rapid curing rate of the composition of the invention, it is also possible to use a “walk-behind” lamp, which allows the operator to apply the coating composition to the wood floor on-site, and walk behind the lamp, curing the coating and immediately walking on the cured surface as the operator moves across the floor.

The examples that follow are intended to illustrate the invention without restricting its scope. Unless otherwise indicated, all %'s and parts are by weight.

### EXAMPLES

In the examples, the following materials were used:

B348—Byk 348, a polyether siloxane flow aid additive available from BYK-Chemie USA

LW44—Borchers LW44, a non-ionic polyurethane based thickening agent available from Borchers

D1293—Dehydran 1293, a polysiloxane defoaming and deaerating agent available from Cognis Corporation

IRG819—Irgacure 819DW photoinitiator, available from Ciba Specialty Chemicals

PU Dispersion A: A mixture of 31.81 parts of IPDI and 15.9 parts of HDI are added to refluxing mixture of 133.12 parts of a polyester acrylate (Laromer LR 8799, available from BASF, having an OH number of 82), 3.24 parts of neopentyl glycol, 8.34 parts of dimethylolpropionic acid, 0.19 parts of dibutylltin dilaurate and 48.16 parts of acetone. The solution is: refluxed for 5 hours with stirring. After cooling the mixture, 5.04 parts of triethylamine are added at 40 C. After cooling to room temperature, the solution is vigorously stirred in 299.32 parts of water which contains 2.99 parts of ethylene diamine. A dispersion is then spontaneously formed. Once the isocyanate groups have completely reacted, the solvent is removed by vacuum distillation. The resultant dispersion has a solids content of 39.13% by weight.

### Example 1

In a 250 ml beaker, 60g of PU Dispersion A was combined with 0.50 grams of Byk 348 and 0.80 grams of Dehydran 1293 under agitation using a Dispermat CV disperser at 1000 rpm. To the mixing vessel was added (under agitation at 1500 rpm) a solution of Borchigel LW-44 (0.09 grams) and tap water (36.8 grams), which were combined prior to addition. The solution was mixed for 10 minutes. Irgacure 819-DW (1.2 grams) was added to the mixing vessel under agitation at 500 rpm and the solution was mixed for five minutes to ensure homogeneity. The formulation was filtered into a plastic jar and left to sit overnight to allow for defoaming.

The wood panels to be coated were cleaned by wiping with a paper towel, which was dampened with a VM&P Naptha/lsopropanol solution (1:1). The formulated UV-curable coating was then applied to the panels at approximately 4 mils (wet film thickness) with a paint brush.

After coating application, the panels were flashed at 50° C. for 10 minutes to remove any water. The coating was cured using a 1200 watt UV-A lamp from H&S Autoshot. The lamp was positioned 1.5 inches from a conveyor belt. The efficacy of the curing setup was tested by running the belt at both 40 and 60 feet per minute. This yielded a total energy density of 250 mJ/cm2 and 200 mJ/cm2, respectively.

The formulation above was compared to a current 2-component waterborne site-applied wood floor coating in pendulum hardness, chemical resistance (MEK double rubs), abrasion resistance (Taber CS-10), and black heel mark resistance (BHMR). The results are shown below:

| | | | | | | | CS-10 | | |
|---|---|---|---|---|---|---|---|---|---|
| | | SPEED | | | HARDNESS | | TABER | BHMR | BHMR |
| RESIN | LIGHT | (ft/min) | DISTANCE | PI % | (SEC) | MEK DR | (MG LOSS) | (HEEL) | (409) |
| 2K PUD/ISO | AIR-DRY | NA | NA | NA | 1 DAY-60 | 30 | 17 | 0 | 0 |
| | | | | | 7 DAY-127 | | | | |
| WB UV PUD | UVA-FL | 40 | 1.5 | 2.2 | 140 | 100 | 24 | 0 | 0 |
| WB UV PUD | UVA-FL | 60 | 1.5 | 2.2 | 140 | 75 | 24 | 0 | 0 |

The hardness of the system according to the invention is achieved shortly after UV cure, whereas the current 2-component technology requires up to one week to develop marginally comparable hardness. There is a three-fold increase in chemical resistance with virtually no change in abrasion and BHMR performance on a scale from “0” to “5”, where “0” indicates no surface marring or downglossing after removal of the heel mark with the heel or Formula 409® cleaner and “5” indicates coating destruction and/or delamination from the substrate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. The present invention is directed to a process for coating a wood substrate, comprising applying an aqueous coating composition to the substrate and subjecting the coated substrate to radiation having a wavelength of 320 nm to 450 nm for'a time sufficient to cure the composition, wherein the aqueous coating composition comprises:
A) a polyurethane dispersion comprising:
a) from about 25 to about 89.8% (and preferably from about 30 to about 80%) by weight of one or more acrylate polymers containing hydroxyl groups and having an OH number of from about 40 to about 240,
b) from 0.1 to about 20% (and preferably from about 2 to about 15%) by weight of one or more compounds containing i) one and/or two functional groups compounds reactive towards isocyanate groups and ii) groups which are cationic and/or anionic and/or have a dispersant action due to ether groups content,
c) from about 10 to about 50% (and preferably from about 15 to about 40%) by weight of one or more di- and/or polyisocyanates,
d) from 0 to about 30% (and preferably from 0 to about 20%) by weight of a di-and/or polyol having a number average molecular weight of up to about 5000, an OH functionality of from 1.2 to 2.2, containing no groups which are cationic or anionic, containing an insufficient amount of ether groups to have a dispersant action, and containing no ethylenically unsaturated groups and
e) from about 0.1 to about 10% (and preferably from about 0.5 to about 7%) by weight of one or more di- and/or polyamines having a number average molecular weight of from about 31 to about 1000,
wherein the percents by weight are based on the total amount of components a) through e) and total 100%,
B) from about 0.1 to about 10% by weight of one or more photoinitiators, wherein the % by weight of component B) is based on the weight of component A), and
C) from about 20 to about 60% by weight of water or a mixture of water and solvent, wherein the % by weight of component C) is based on the solids content of component A).

2. The process of claim 1, wherein component a) is used in amount of from about 30 to about 80% by weight, component b) is used in amount of from about 2 to about 15% by weight, component c) is used in amount of from about 15 to about 40% by weight, component d) is used in amount of from about 0 to about 20% by weight and component e) is used in amount of from about 0.5 to about 7% by weight.

3. The process of claim 1, wherein component a) contains from about 0.1 to about 10 moles/kg, based on the weight of component a), of C=C bonds.

4. The process of claim 1, wherein component A) has a solids content of from about 30 to about 55% by weight.
